(19) United States
(12) Patent Application Publication
(10) Pub. No.: US 2020/0398205 A1
(43) Pub. Date: Dec. 24, 2020

(54) ENCLOSURE AIR INTAKE STRUCTURE

(71) Applicant: HONDA MOTOR CO., LTD., Tokyo (JP)

(72) Inventor: Junji Hiranuma, Wako-shi (JP)

(21) Appl. No.: 16/903,424

(22) Filed: Jun. 17, 2020

(30) Foreign Application Priority Data
Jun. 18, 2019 (JP) 2019-112453

(51) Int. Cl. B01D 46/00; H01M 8/2475; H01M 8/04014; H01M 8/04701; B01D 46/10

(52) U.S. Cl. CPC B01D 46/0006; H01M 8/2475; H01M 8/04014; B01D 2279/45; B01D 46/0036; B01D 46/10; H01M 8/04701

(57) ABSTRACT

An enclosure air intake structure includes louver-shaped air intake ports provided on an enclosure, a filter that is disposed in a vicinity of the air intake ports inside the enclosure and absorbs a liquid that has entered the enclosure through the air intake ports while preventing dust from entering the enclosure through the air intake ports, a filter holder that retains the filter inside the enclosure, discharge ports through which the liquid absorbed by the filter is discharged to the exterior, a separation mechanism that separates the liquid and the dust, and a retaining mechanism that retains the dust that has been separated by the separation mechanism.

### CROSS-REFERENCE TO RELATED APPLICATION

This application is based upon and claims the benefit of priority from Japanese Patent Application No. 2019-112453 filed on Jun. 18, 2019, the contents of which are incorporated herein by reference.

### BACKGROUND OF THE INVENTION

### Field of the Invention

The present invention relates to an enclosure air intake structure in which outside air is drawn into an enclosure via air intake ports.

### Description of the Related Art

For example, in an enclosure in which electric power equipment and the like is accommodated, such as a cogeneration system using a fuel cell, the electric power equipment is cooled by introducing outside air from air intake ports, so that the temperature inside the enclosure does not exceed an allowable temperature for the components (components of the electric power equipment) inside the enclosure, whereby the temperature inside the enclosure is controlled.

In Japanese Laid-Open Patent Publication No. 2016-219346, a structure is disclosed in which outside air is introduced into an enclosure through louver-shaped air intake ports, and the air is discharged through discharge ports disposed below the air intake ports.

### SUMMARY OF THE INVENTION

Incidentally, when rainwater (liquid) and dust mixed within the outside air enter the enclosure through the air intake ports, corrosion of components inside the enclosure may occur, and there is a possibility that the useful life of the product may be shortened.

Thus, according to the above-described publication, the louver-shaped air intake ports are provided so as to prevent the entry of rainwater. Even so, since a certain amount of splashing rainwater and dust enters the enclosure, according to the above-described publication, the rainwater that has entered the enclosure is discharged to the exterior from the discharge ports disposed below the air intake ports.

However, in a product such as a cogeneration system in which a prolonged period of use (for example, a period of use of ten years or more) is required, due to such a prolonged period of use, a problem arises in that relatively large dust particles tend to block the discharge ports, and the rainwater cannot be smoothly discharged.

The present invention has been devised taking into consideration the aforementioned problem, and has the object of providing an enclosure air intake structure in which, by preventing dust from blocking the discharge ports, liquid having entered the enclosure through the air intake ports can be smoothly discharged from the discharge ports, and a reduction in the useful life of the product can be avoided.

An aspect of the present invention relates to an enclosure air intake structure comprising a louver-shaped air intake port provided on an enclosure, a filter disposed in a vicinity of the air intake port inside the enclosure and configured to absorb a liquid that has entered the enclosure through the air intake port while preventing dust from entering the enclosure through the air intake port, a filter holder provided inside the enclosure and configured to retain the filter, and a discharge port provided on the enclosure and configured to discharge the liquid absorbed by the filter to an exterior. In addition, the enclosure air intake structure further comprises a separation mechanism configured to separate the liquid and the dust, and a retaining mechanism configured to retain the dust that has been separated by the separation mechanism.

According to the present invention, since the dust that has been separated by the separation mechanism is retained by the retaining mechanism, it is possible to prevent such dust from blocking the discharge port. Consequently, any liquid that has entered through the air intake port can be smoothly discharged from the discharge port. As a result, it is possible to avoid a reduction in the useful life of a product such as a cogeneration system to which the enclosure air intake structure according to the present invention is applied.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of an enclosure to which an air intake structure according to a present embodiment is applied;

FIG. 2 is a partially exploded perspective view of the air intake structure shown in FIG. 1;

FIG. 3 is a partial perspective view of a filter holder shown in FIG. 2;

FIG. 4 is a partial perspective view of the filter holder shown in FIG. 2; and

FIG. 5 is an explanatory diagram illustrating operations according to the present embodiment.

### DESCRIPTION OF THE PREFERRED EMBODIMENTS

Hereinafter, a preferred embodiment of an enclosure air intake structure according to the present invention will be illustrated and described in an exemplary manner with reference to the accompanying drawings.

### 1. Configuration of the Present Embodiment

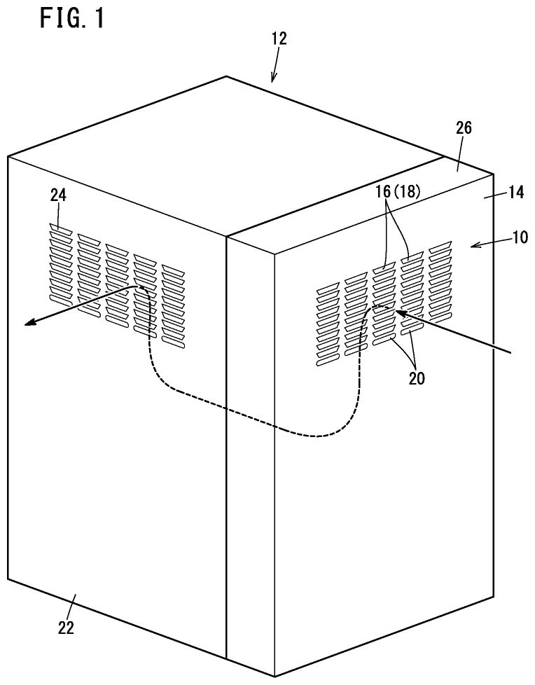

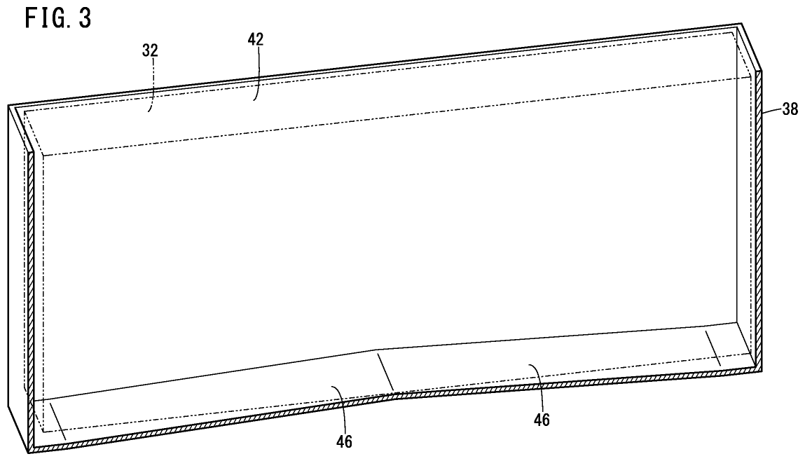

An enclosure air intake structure 10 according to the present embodiment (hereinafter, also referred to as an air intake structure 10 according to the present embodiment) will be described with reference to FIGS. 1 to 5. The air intake structure 10 is applied to an enclosure 12 shown in FIG. 1. The enclosure 12, for example, is an enclosure for a cogeneration system in which a fuel cell is used, and accommodates electric power equipment such as the fuel cell. The enclosure 12 is of a rectangular shape, and one surface 14 thereof is a maintenance surface which is capable of being detached or opened and closed.

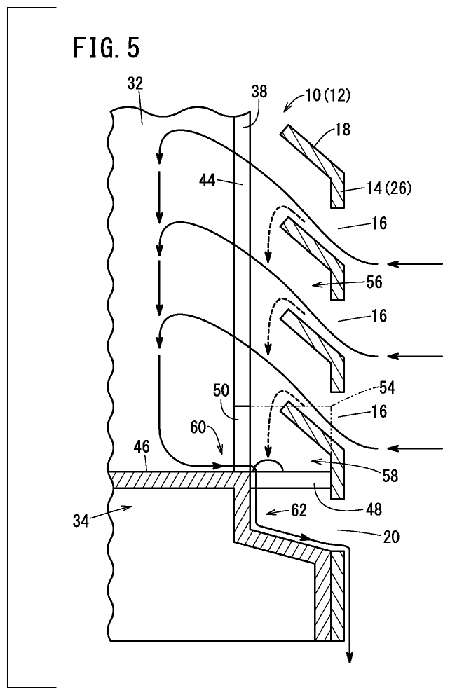

A plurality of louver-shaped air intake ports 16 are provided on an upper side portion of the one surface 14 of the enclosure 12. The plurality of air intake ports 16 are provided on the one surface 14 at predetermined intervals in a vertical direction and in a horizontal direction, and enable outside air to be introduced into the enclosure 12. More specifically, a plurality of louvers 18, which extend in the horizontal direction and are inclined obliquely downward from the interior to the exterior of the enclosure 12, are provided on the upper side portion of the one surface 14 of the enclosure 12, at predetermined intervals in the vertical direction and in the horizontal direction, and the air intake ports 16 are each formed below each of the louvers 18 (see FIG. 5).

Further, on the upper side portion of the one surface 14 of the enclosure 12, a plurality of discharge ports 20 are disposed at predetermined intervals in the horizontal direction below the plurality of air intake ports 16. The louvers 18 are not provided for the plurality of discharge ports 20.

On the other hand, a plurality of exhaust ports 24 are disposed at predetermined intervals in the vertical direction and in the horizontal direction on an upper side portion of another side surface 22 that is perpendicular to the one surface 14 of the enclosure 12. The plurality of exhaust ports 24, in the same manner as the plurality of air intake ports 16, are preferably louver-shaped.

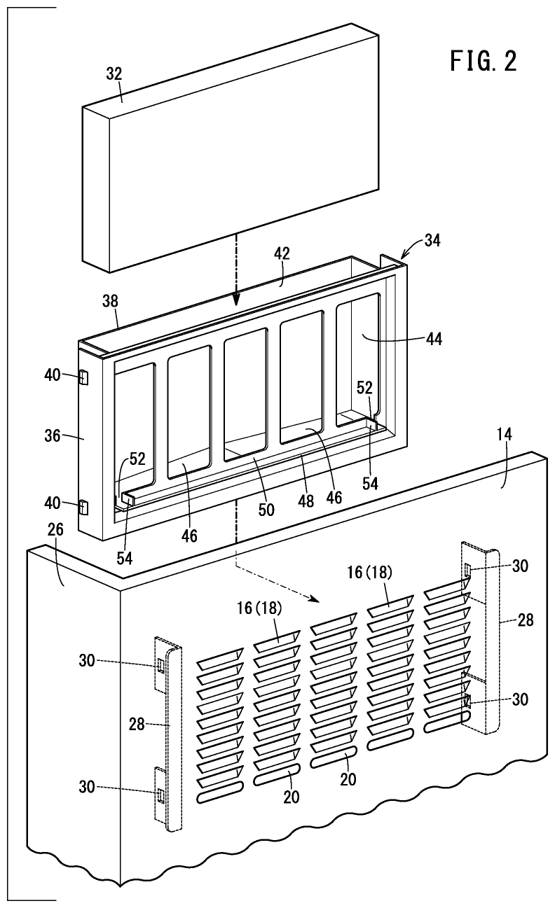

As shown in FIG. 2, two holder fixtures 28 are provided on an inner side of an outer plate 26 of the enclosure 12 constituting the one surface 14 (maintenance surface), with the plurality of air intake ports 16 and the plurality of discharge ports 20 being interposed between the holder fixtures 28. The two holder fixtures 28 have shapes extending in the vertical direction along the inner side of the outer plate 26, and upper end parts and lower end parts thereof project inwardly of the enclosure 12. Engagement holes 30 are formed at the upper end part and the lower end part of each of the holder fixtures 28.

A filter holder 34 in which a filter 32 is retained is attached to the respective holder fixtures 28. The filter 32, for example, is a plate-shaped sponge filter made of resin, and prevents dust from entering the enclosure 12 via the air intake ports 16, while on the other hand, absorbs liquid such as rainwater that enters the enclosure 12 through the air intake ports 16.

The filter holder 34 is a member made of resin having a frame body 36, and a filter accommodating unit 38 which is provided on the inner side of the frame body 36 and in which the plate-shaped filter 32 is accommodated. Protrusions 40 that engage with the engagement holes 30 are provided at upper and lower locations on both ends of the frame body 36 along a horizontal direction. Accordingly, by the respective protrusions 40 engaging with the respective engagement holes 30, the filter holder 34 is fixed to the two holder fixtures 28 in a state of facing the plurality of air intake ports 16. Stated otherwise, the filter holder 34 is detachably arranged on the side of the air intake ports 16 and on the side of the discharge ports 20 inside the enclosure 12.

The filter accommodating unit 38 is a box-shaped body that is provided on the inner side of the frame body 36, and the top thereof is left open. By being inserted from an opening 42 on the upper side of the filter accommodating unit 38, the filter 32 is accommodated in the filter accommodating unit 38. In the filter accommodating unit 38, a plurality of openings 44 are provided at predetermined intervals in the horizontal direction, on the side of the one surface 14 (the plurality of air intake ports 16 and the plurality of discharge ports 20) of the enclosure 12. Further, a bottom surface of the filter accommodating unit 38 is constituted in the form of inclined portions 46, which are inclined downward from a central portion thereof along the horizontal direction. More specifically, the two inclined portions 46 are provided symmetrically with respect to the central portion of the bottom surface of the filter accommodating unit 38. Accordingly, the filter accommodating unit 38 supports the accommodated filter 32 by four side surfaces and the central portion of the bottom surface.

A first rib 48 (first partition plate), which projects in the horizontal direction toward the one surface 14 of the enclosure 12, is formed on the bottom surface of the filter accommodating unit 38. As shown in FIG. 5, in a state in which the filter holder 34 is fixed to the two holder fixtures 28, the first rib 48 partitions a space between the one surface 14 of the enclosure 12 and the filter 32 on the side of the air intake ports 16 inside the enclosure 12 into a space on the side of the air intake ports 16 and a space on the side of the discharge ports 20.

Further, by providing the plurality of openings 44 in the filter accommodating unit 38 on the side of the one surface 14 of the enclosure 12, a rib-shaped support member 50 is formed, which is erected from the bottom surface of the filter accommodating unit 38, and supports the filter 32 on the side of the air intake ports 16. Cutouts 52 are formed respectively at both ends of the support member 50 in the horizontal direction. Accordingly, the two cutouts 52 enable communication between ends of the inclined portions 46 in the horizontal direction, and the space on the side of the one surface 14 inside the enclosure 12. On an upper surface of the first rib 48, second ribs 54 (second partition plates), which extend from the support member 50 toward the side of the one surface 14 of the enclosure 12, are provided at locations where the two cutouts 52 of the support member 50 are formed.

In addition, with the air intake structure 10 according to the present embodiment, in the enclosure 12, the filter 32 which is disposed in the vicinity of the plurality of air intake ports 16 prevents dust from entering the enclosure 12 through the air intake ports 16, while on the other hand, absorbs liquid that has entered the enclosure 12 through the plurality of air intake ports 16. In this case, the air intake structure 10 comprises a separation mechanism 56 that separates the liquid and the dust, and a retaining mechanism 58 that retains the dust that has been separated by the separation mechanism 56. More specifically, the separation mechanism 56 is constituted by the louver-shaped air intake ports 16, and the filter 32 on the side of the air intake ports 16. Further, the retaining mechanism 58 includes the first rib 48 and the second ribs 54.

Further, the air intake structure 10 according to the present embodiment further comprises a guide mechanism 60 that guides the liquid absorbed by the filter 32, from a lower side portion of the filter 32 to the discharge ports 20. In this case, the second ribs 54 partition the retaining mechanism 58 from the guide mechanism 60. The guide mechanism 60 includes the aforementioned two inclined portions 46, and a guide member 62 that guides the liquid from the end of each of the inclined portions 46 to the discharge ports 20. The guide member 62 is a portion of the filter holder 34 through which the liquid flows between the inclined portions 46 and the discharge ports 20. The second ribs 54 partition the retaining mechanism 58 from the inclined portions 46 and the guide member 62.

Furthermore, in the air intake structure 10 according to the present embodiment, the filter holder 34 is detachably arranged on the side of the air intake ports 16 and the side of the discharge ports 20 inside the enclosure 12. Therefore, by fixing the filter holder 34 to the holder fixtures 28 in a state in which the filter 32 is installed in the filter holder 34, the separation mechanism 56 and the retaining mechanism 58 can be disposed between both the filter 32 and the filter holder 34 and both the plurality of air intake ports 16 and the plurality of discharge ports 20.

### 2. Operations of the Present Embodiment

Operations of the air intake structure 10 according to the present embodiment which is configured in the manner described above will be described with reference to FIGS. 1 to 5.

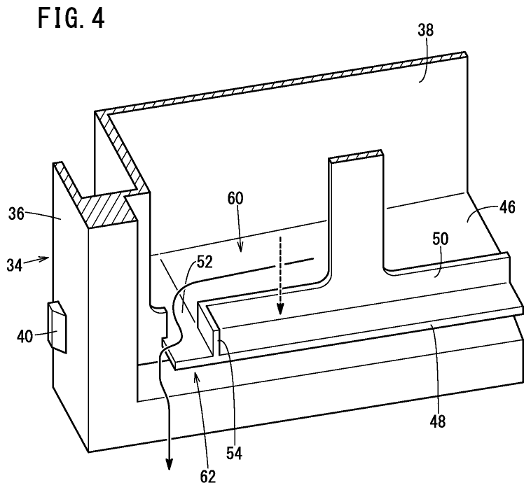

First, as shown by the solid line arrow in FIG. 1, outside air is introduced into the enclosure 12 through the plurality of air intake ports 16. In this case, because the plurality of air intake ports 16 are louver-shaped, to a certain extent, it is possible to prevent liquid such as rainwater and dust from entering the enclosure 12. Notwithstanding, in the case that splashing liquid (the solid line arrows in FIG. 5) and dust (the dashed line arrows in FIG. 5) have entered the enclosure 12 by passing over the louvers 18 from the plurality of air intake ports 16, then in the separation mechanism 56, the liquid that has entered is absorbed by the filter 32 on the side of the air intake ports 16. Further, in the separation mechanism 56, as shown by the dashed line arrows in FIGS. 4 and 5, the dust that has entered collides against the filter 32 on the side of the air intake ports 16, and falls downward under its own weight. The fallen dust is accumulated on the upper surface of the first rib 48.

The liquid absorbed by the filter 32 moves downward inside the filter 32, and drops onto the inclined portions 46 from the lower side portion of the filter 32. Since the inclined portions 46 are inclined downward toward the cutouts 52, the liquid that has dropped downward flows along the inclined portions 46, passes through the cutouts 52 and the guide member 62, and is discharged to the exterior from the discharge ports 20 as shown by the solid line arrows in FIGS. 4 and 5.

On the other hand, as shown by the dashed line in FIG. 1, the outside air, which has been introduced into the enclosure 12 and separated from the liquid and the dust, passes through the filter 32, flows as a cooling wind in the enclosure 12, and cools the non-illustrated internal components inside the enclosure 12. Thereafter, as shown by the solid line arrow in FIG. 1, the cooling wind (outside air) after having performed cooling is exhausted from the exhaust ports 24.

Since the interior of the enclosure 12 is exposed by opening or detaching the outer plate 26 of the one surface 14 of the enclosure 12, the filter holder 34 can be detached from the holder fixtures 28, and the dust accumulated on the first rib 48 can be removed. Further, in a state in which the outer plate 26 of the one surface 14 of the enclosure 12 is opened or detached, it is possible to replace and exchange the filter 32 that is accommodated in the filter holder 34.

### 3. Advantages and Effects of the Present Embodiment

As has been described above, the air intake structure 10 according to the present embodiment is equipped with the louver-shaped air intake ports 16 provided on the enclosure 12, the filter 32 that is disposed in the vicinity of the air intake ports 16 inside the enclosure 12, and absorbs the liquid that has entered the enclosure 12 through the air intake ports 16, while preventing dust from entering the enclosure 12 through the air intake ports 16, the filter holder 34 that is provided inside the enclosure 12 and retains the filter 32, and the discharge ports 20 which are provided on the enclosure 12 and through which the liquid absorbed by the filter 32 is discharged to the exterior. In addition, the air intake structure 10 further comprises the separation mechanism 56 that separates the liquid and the dust, and the retaining mechanism 58 that retains the dust that has been separated by the separation mechanism 56.

In accordance with such a configuration, since the dust that has been separated by the separation mechanism 56 is retained by the retaining mechanism 58, it is possible to prevent such dust from blocking the discharge ports 20. Consequently, any liquid that has entered through the air intake ports 16 can be smoothly discharged from the discharge ports 20. As a result, it is possible to avoid a reduction in the useful life of a product such as a cogeneration system to which the air intake structure 10 is applied.

In this case, the separation mechanism 56 is constituted by the air intake ports 16, and the filter 32 on the side of the air intake ports 16. In accordance with this feature, the liquid is absorbed by the filter 32 on the side of the air intake ports 16, and the dust collides against the filter 32 on the side of the air intake ports 16 and falls downward. As a result, the liquid and the dust can be separated simply and easily.

Further, the air intake ports 16 are provided on the one surface 14 of the enclosure 12, and the discharge ports 20 are disposed below the air intake ports 16 on the one surface 14 of the enclosure 12. The retaining mechanism 58 includes the first rib 48 (first partition plate) that extends in the horizontal direction inside the enclosure 12 in the space between the one surface 14 and the filter 32 on the side of the air intake ports 16, thereby partitioning the space into a space on the side of the air intake ports 16 and a space on the side of the discharge ports 20. In accordance with such features, it is possible to reliably prevent the dust accumulated on the first rib 48 from falling down and blocking the discharge ports 20.

In this case, the first rib 48 projects in the horizontal direction from the filter holder 34 toward the one surface 14 of the enclosure 12. In accordance with this feature, with a simple configuration, a portion for accumulating dust can be provided.

In addition, the air intake structure 10 further comprises the guide mechanism 60 that guides the liquid absorbed by the filter 32, from the lower side portion of the filter 32 to the discharge ports 20. In this case, the retaining mechanism 58 includes the second ribs 54 (second partition plates) that partition the retaining mechanism 58 from the guide mechanism 60. In accordance with such features, it is possible to reliably prevent the dust accumulated on the retaining mechanism 58 from moving to the guide mechanism 60 and the discharge ports 20.

Further, the guide mechanism 60 is disposed below the filter 32 in the filter holder 34, and includes the inclined portions 46 that are inclined toward the discharge ports 20, and the guide member 62 that guides the liquid to the discharge ports 20 from the inclined portions 46 on the side of the discharge ports 20. In this case, the second ribs 54 project from the filter holder 34, and partition the retaining mechanism 58 from the inclined portions 46 and the guide member 62. In accordance with such features, while the dust is prevented from moving to the guide mechanism 60 and the discharge ports 20, it can be made easier for the liquid that has dropped downward from the lower side portion of the filter 32 to flow from the inclined portions 46 to the discharge ports 20 via the guide member 62.

Furthermore, the filter holder 34 is detachably arranged on the side of the air intake ports 16 and on the side of the discharge ports 20 inside the enclosure 12. In this case, by attaching the filter holder 34 on the side of the air intake ports 16 and on the side of the discharge ports 20 inside the enclosure 12 in a state in which the filter 32 is installed in the filter holder 34, the separation mechanism 56 and the retaining mechanism 58 are disposed between both the filter 32 and the filter holder 34 and both the air intake ports 16 and the discharge ports 20. In accordance with such features, without the addition of new components, it is possible to realize separation of the liquid and the dust from each other, accumulation of the dust, and an improvement in maintainability of the air intake structure 10.

It should be noted that the present invention is not limited to the embodiment described above, and it goes without saying that various additional or alternative configurations could be adopted therein on the basis of the descriptive content of the present specification.

What is claimed is:

1. An enclosure air intake structure comprising a louver-shaped air intake port provided on an enclosure, a filter disposed in a vicinity of the air intake port inside the enclosure and configured to absorb a liquid that has entered the enclosure through the air intake port while preventing dust from entering the enclosure through the air intake port, a filter holder provided inside the enclosure and configured to retain the filter, and a discharge port provided on the enclosure and configured to discharge the liquid absorbed by the filter to an exterior,
the enclosure air intake structure further comprising:
a separation mechanism configured to separate the liquid and the dust; and
a retaining mechanism configured to retain the dust that has been separated by the separation mechanism.

2. The enclosure air intake structure according to claim 1, wherein the separation mechanism is constituted by the air intake port, and the filter on a side of the air intake port.

3. The enclosure air intake structure according to claim 1, wherein:
the air intake port is provided on one surface of the enclosure;
the discharge port is disposed below the air intake port on the one surface; and
the retaining mechanism comprises a first partition plate configured to extend in a horizontal direction inside the enclosure in a space between the one surface and the filter on a side of the air intake port, thereby partitioning the space into a space on the side of the air intake port and a space on a side of the discharge port.

4. The enclosure air intake structure according to claim 3, wherein the first partition plate is a rib projecting in the horizontal direction from the filter holder toward the one surface.

5. The enclosure air intake structure according to claim 1, further comprising a guide mechanism configured to guide the liquid absorbed by the filter, from a lower side portion of the filter to the discharge port,
wherein the retaining mechanism comprises a second partition plate configured to partition the retaining mechanism from the guide mechanism.

6. The enclosure air intake structure according to claim 5, wherein:
the guide mechanism is disposed below the filter in the filter holder, and includes an inclined portion inclined toward the discharge port, and a guide member configured to guide the liquid to the discharge port from the inclined portion on a side of the discharge port; and
the second partition plate is a rib projecting from the filter holder and configured to partition the retaining mechanism from the inclined portion and the guide portion.

7. The enclosure air intake structure according to claim 1, wherein:
the filter holder is detachably arranged on a side of the air intake port and on a side of the discharge port inside the enclosure; and
by attaching the filter holder on the side of the air intake port and on the side of the discharge port inside the enclosure in a state in which the filter is installed in the filter holder, the separation mechanism and the retaining mechanism are disposed between both the filter and the filter holder and both the air intake port and the discharge port.
